(19) United States
(12) Patent Application Publication
(10) Pub. No.: US 2012/0129140 A1
(43) Pub. Date: May 24, 2012

(54) DENTAL MANIKIN

(76) Inventors: Chad J. Wren, Angola, IN (US); Masahiro Furuki, Shiga (JP)

(21) Appl. No.: 13/298,569

(22) Filed: Nov. 17, 2011

Related U.S. Application Data
(60) Provisional application No. 61/415,585, filed on Nov. 19, 2010.

(51) Int. Cl. A61C 11/00

(52) U.S. Cl. 434/263

(57) ABSTRACT

A dental simulator having a simulated teeth assembly, a manikin head and a locking mechanism. The manikin head is configured to receive the simulated teeth assembly. A locking mechanism includes a receiving portion and an interacting portion. The interacting portion is slidingly engaged with the receiving portion to thereby secure the simulated teeth assembly to the manikin head. Either the receiving portion or the interacting portion is connected to the simulated teeth assembly and the other of the receiving and interacting portion are connected to the manikin head.

### CROSS REFERENCE TO RELATED APPLICATIONS

This is a non-provisional application based upon U.S. provisional patent application Ser. No. 61/415,585, entitled “DENTAL MANIKIN”, filed Nov. 19, 2010, which is incorporated herein by reference.

### BACKGROUND OF THE INVENTION

1. Field of the Invention

The present invention relates to a dental manikin, and, more particularly, to a method and apparatus to hold simulated teeth in the head of a manikin.

2. Description of the Related Art

Dental manikins are utilized for the training of dental assistance and hygienists and typically include a simulated skull and mouth opening with simulated teeth utilized for the training process. The student performs many of the techniques prior to using those techniques on humans. A set of teeth may be assigned to each student which is then inserted into manikin head for their particular use during the training course. The teeth are secured in the head by way of a screw that is tightened to the at least one of the portions of the manikin head to thereby manikin head may be connected to a chair mount mechanism or a bench mount in order to simulate practical situations to accomplish various training goals which is restorative or prosthetic devices associated with teeth and gums.

The problem with the current dental manikins is that the process of installing the teeth in the manikin head is both time consuming and subject to potential misalignment.

What is needed in the art is an insertion method and apparatus that allows for the efficient insertion and removal of the teeth from the manikin head in an economical manner.

### SUMMARY OF THE INVENTION

The present invention relates to a dental simulator, more particularly to a dental simulator having a simulated teeth assembly, a manikin head and a locking mechanism. The manikin head is configured to receive the simulated teeth assembly. A locking mechanism includes a receiving portion and an interacting portion. The interacting portion is slidingly engaged with the receiving portion to thereby secure the simulated teeth assembly to the manikin head. Either the receiving portion or the interacting portion is connected to the simulated teeth assembly and the other of the receiving and interacting portion is connected to the manikin head.

Another embodiment of the present invention includes a method of securing a simulated teeth assembly to a manikin head, the method including the steps orienting and sliding. The orienting step includes orienting a receiving portion of a locking mechanism with an interacting portion of the locking mechanism. The sliding step includes sliding the receiving portion and the interacting portion together to thereby secure the simulated teeth assembly to the manikin head. The receiving portion or the interacting portion is connected to the simulated teeth assembly and the other is connected to the manikin head.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 is a perspective view of an embodiment of a manikin head of the present invention;

FIG. 2 is an exploded view of the manikin head of FIG. 1;

FIG. 3 is another perspective view of the manikin head of FIGS. 1 and 2;

FIG. 4 is an exploded view of the quick release assembly used in the manikin head of FIGS. 1-3;

FIG. 5 is a receiving plate of the quick release mechanism of FIG. 4;

FIG. 6 is a side view of the manikin head of FIGS. 1-3;

FIG. 7 is a partial view of the manikin head of FIGS. 1-3 and 6;

FIG. 8 is a partial perspective view of the chin of manikin head of FIGS. 1-3 and 6; and

FIG. 9 is a partial perspective view of manikin head of FIGS. 1-3 and 6.

Corresponding reference characters indicate corresponding parts throughout the several views. The exemplification set out herein illustrates one embodiment of the invention, in one form, and such exemplification is not to be construed as limiting the scope of the invention in any manner.

### DETAILED DESCRIPTION OF THE INVENTION

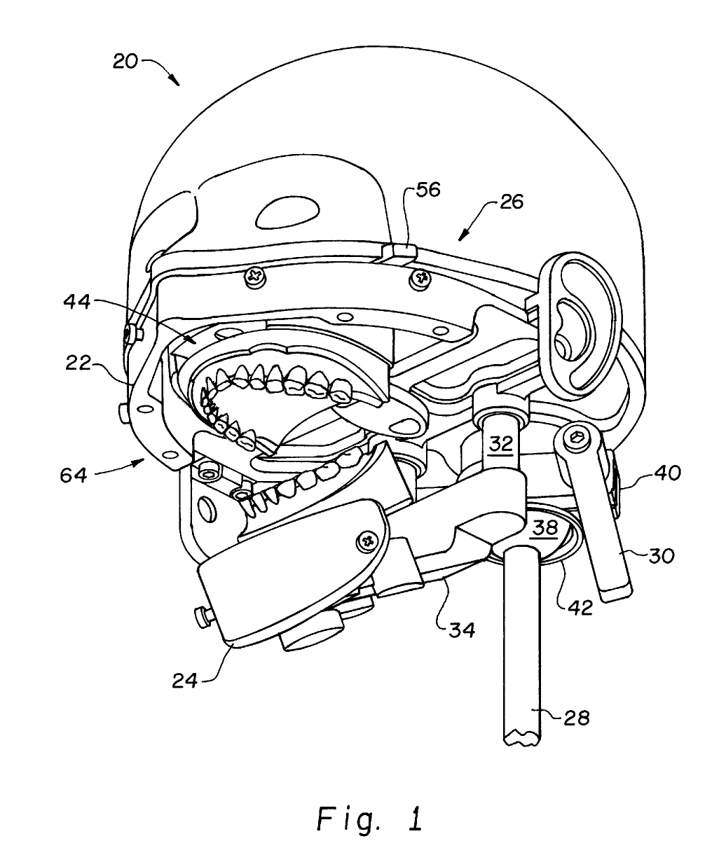

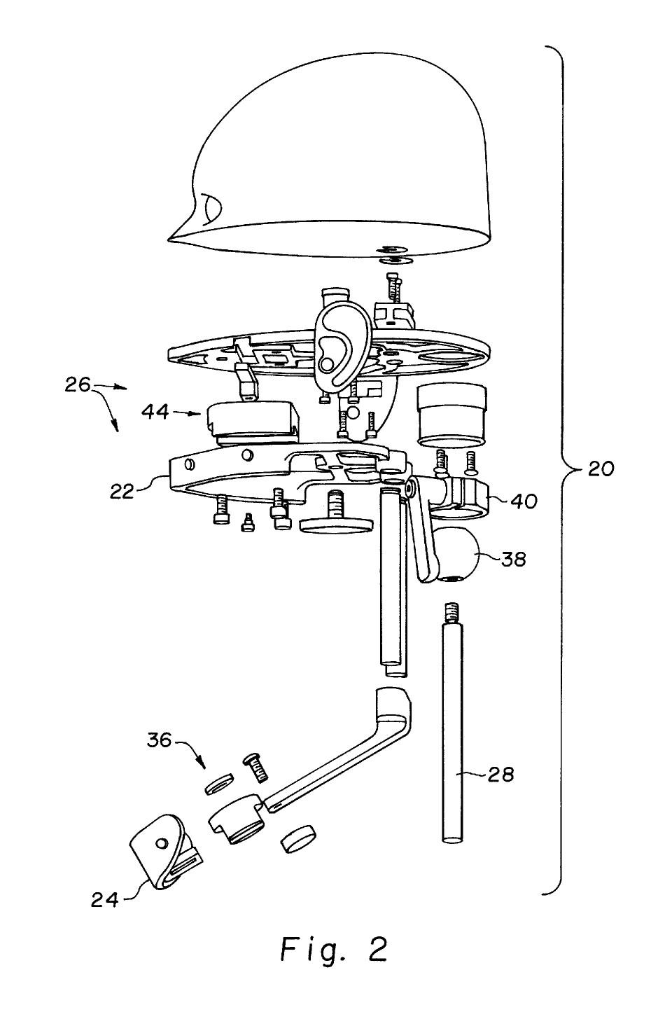

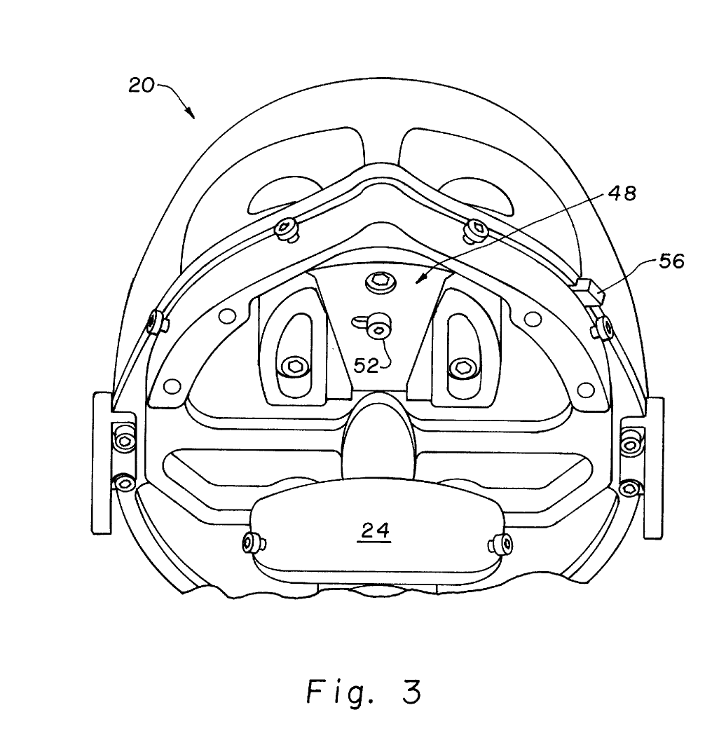

Referring now to the drawings, and more particularly to FIG. 1-3, there is illustrated a manikin head 20 including a mask frame 22, a chin 24, a quick release mechanism 26, a rod 28, a handle 30, an articulator rod 32, an articulator base 34, a magnetic housing 36, a ball 38, a locking collar 40, a sleeve 42 and a locking mechanism 44. Manikin head 20 is used in a dental student training program allowing for the quick and easy replacement of both upper and lower jaw models, therein. It allows the articulator to remain attached to the manikin during the attachment/detachment of the jaw model. The maintaining of the typodont's occlusion is achieved by way of release mechanism 26.

Mask frame 22 slides along articulator rods 32 to allow for the easy detaching and attaching of a rubber mask, not shown. Chin 24 is connected to articulator base 34 proximate to magnetic housing 36. Rod 28 is connected to ball 38 allowing for the manipulation of manikin head 20 thereabout with handle 30 tightening a locking collar 40 on ball 38 when manikin 20 is properly positioned. Chin 24 can be adjusted by loosening a knob thereon and retightening it to thereby position chin 24 at the desired position along articular base 34. Magnetic housing 36 is held in place on articulator base 34 by friction and may be slid to adjust its position along articular base 34.

Ball 38 is pressed into a sleeve 42, which is machined from a resilient material. Sleeve 42 then is positioned within collar 40 so that collar 40 can be positioned thereon to position manikin head 20 in its desired position. When ball 38 is pressed into sleeve 42, sleeve 42 stretches and snaps back over ball 38 as it is inserted, thereby providing for a strong, smooth operation. Locking collar 40 can be rotated about sleeve 42 and ball 38 so as to position handle 30 in a desirable position.

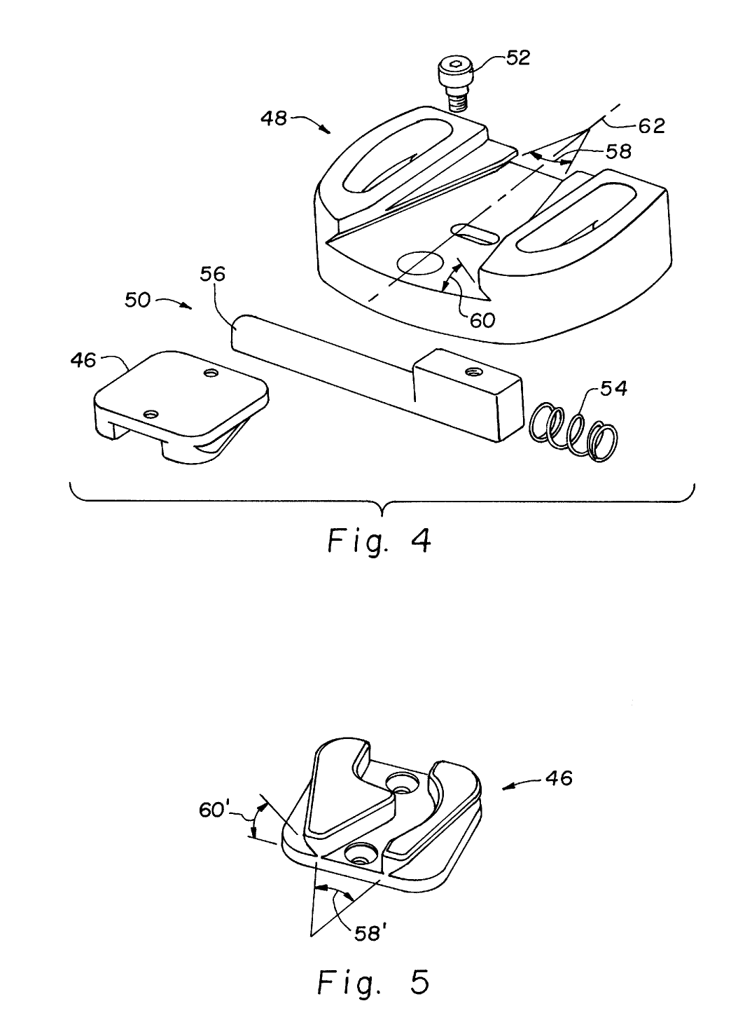

Now additionally referring to FIGS. 4 and 5, quick release mechanism 26 collectively includes locking mechanism 44 as well as magnet housing 36. Locking mechanism 44 includes a receiving portion 46, an interacting portion 48, and a release assembly 50 having a protrusion 52, a spring 54, and a push button 56, also known as a release device 56. Receiving portion 46 and interacting portion 48 have some complimentary features allowing receiving portion 46 to wedgingly engage interacting portion 48. Push button 56 extends out of the side of manikin 20 allowing a student to easily push the button to overcome the biasing of spring 54, also known as a biasing device 54, to thereby position protrusion 52 in a portion of receiving portion 46 so that simulated teeth assembly 64 can be removed the manikin head 20. Additionally, magnet 36 holds the lower part of simulated teeth assembly 64 to the lower part of manikin 20 which is removed by the student simply overcoming the magnetic attraction to the bottom portion of simulated teeth assembly 64. For clarity in FIG. 1 a hinged connecting assembly between the upper and lower jaw of simulated teeth assembly 64 is not shown.

Protrusion 52 may be screwed into push button 56 thereby helping to secure the two parts to interacting portion 48. Interacting portion 48 is arranged so that protrusion 52 operates in a slot that allows the lateral movement of protrusion 52 relative to interacting portion 48. Receiving portion 46 and interacting portion 48 have dual angle complimentary features illustrated at angle 58, angle 58′, angle 60 and angle 60′. Angles 58 and 60 of interacting portion 48 can be seen relative to insertion axis 62, which may also be considered an insertion plane with angles 58 and 60 allowing for a wedging of the complimentary features of receiving portion 46 as receiving portion 46 is inserted into interacting portion 48. Complimentary angles 58′ and 60′ co-act with angles 58 and 60 so as to wedge receiving portion 46 to interacting portion 48 as receiving portion 46 is inserted along insertion axis 62. Additionally, the pathway provided in receiving portion 46 functions as a cam lock 66 as protrusion 52 travels along the cam lock path 66. Looking at FIG. 5 as protrusion 52 initially enters the cam lock path 66 from the front of receiving portion 46 is illustrated in FIG. 5 it travels along the path causing biasing device 54 to be compressed as it travels up the path and then protrusion 52 snaps back to what is shown as the left of FIG. 5 thereby locking receiving portion 46 interacting portion 48 to thereby secure simulated teeth assembly 64 in position in manikin head 20. As can be seen in the figures push button 56 is pressed then receiving portion 46 may be slid away from interacting portion 48 to release the simulated teeth assembly 64 from manikin head 20. The double angle features on each side of receiving portion 46 and complimentary angles in interacting portion 48 allow for securing secured positioning of simulated teeth assembly 64.

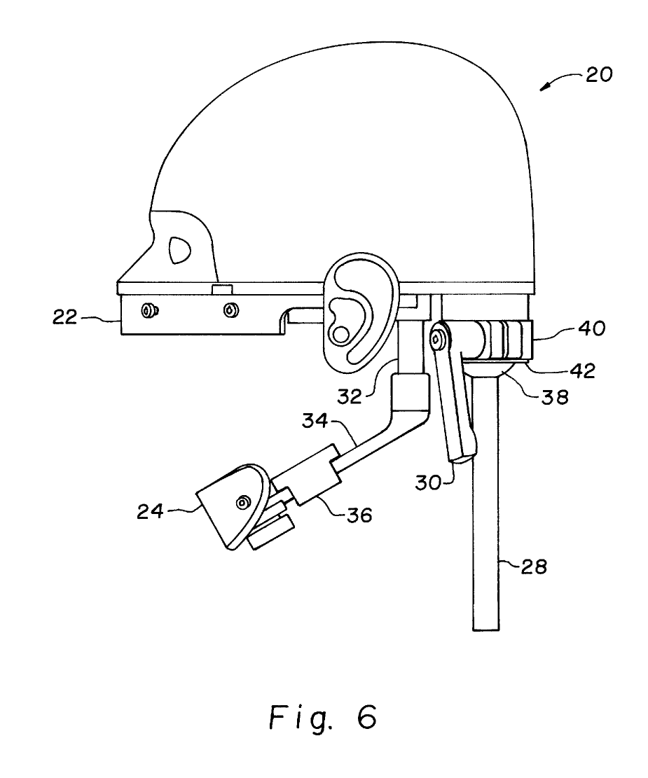

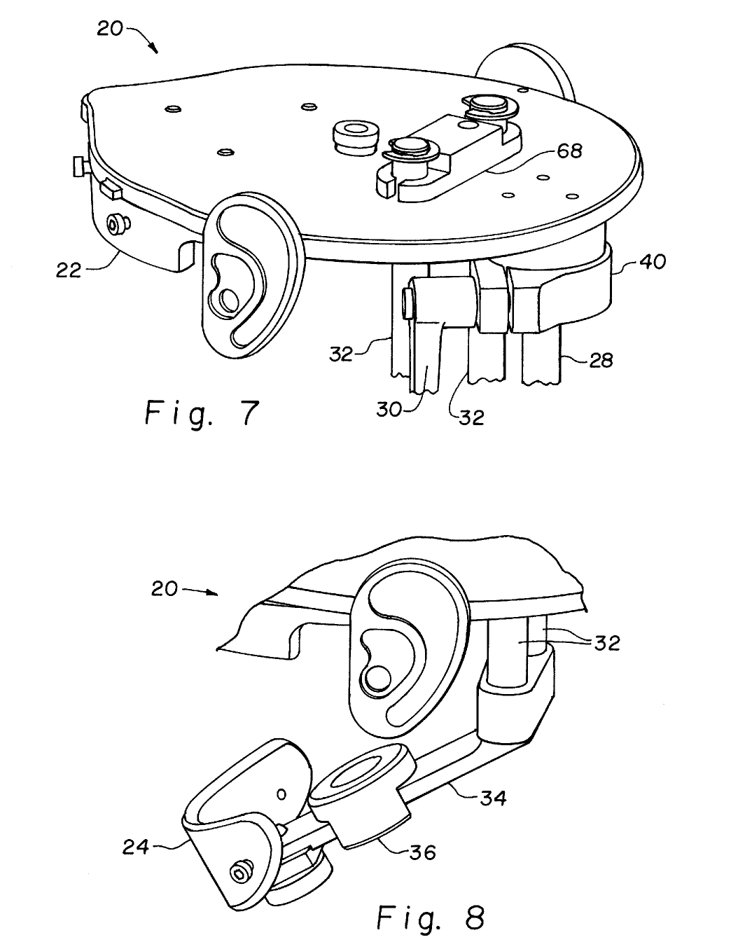

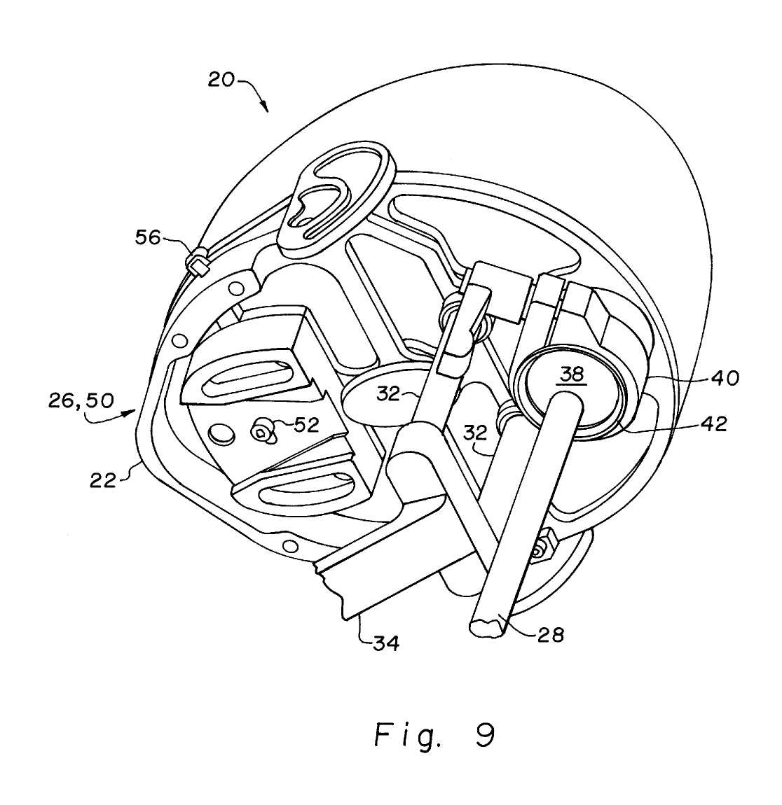

Now, additionally referring to FIGS. 6-9 articulator rods 32 extend through a friction block 68 allowing for repositioning of articulator base 34. Interaction between articulator rods 32 and friction block 68 allows for easy positioning yet retention of articulator base in a desired position. Articulator rods 32 glide up and down into manikin head 20 by simply pushing or pulling parallel to articulator rods 32. During use the normal loads applied to the jaw at an angle to articulator rods 32 cause the binding action to lock articulator base 44 into position, being held there by friction block 68, which maintains a constant tension on articulator rods 32, allowing for the easy, smooth movement until a binding force is applied at an angle thereto.

Advantageously the present invention allows for use of mask frame 22, allowing for the attachment of a rubber mask without having to completely detach any part of manikin 20 to install the mask thereon. Another advantage of the present invention is that the jaw shown as simulated teeth assembly 64 can be easily and quickly released and removed or inserted into manikin 20. Another advantage is that the ball and socket base of manikin head 20 is easily adjusted and positioned allowing for the secured positioning of manikin head 20 relative to rod 28. Yet further friction block 68 allows for the quick yet secured positioning of articulator base 34 relative to other portions of manikin head 20.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A dental simulator, comprising:
a simulated teeth assembly;
a manikin head configured to receive said simulated teeth assembly; and
a locking mechanism including:
a receiving portion; and
an interacting portion slidingly engaged with said receiving portion to thereby secure said simulated teeth assembly to said manikin head, one of said receiving portion and said interacting portion being connected to said simulated teeth assembly, the other of said receiving portion and said interacting portion being connected to said manikin head.

2. The dental simulator of claim 1, wherein said interacting portion has a protrusion and said receiving portion has a surface against which said protrusion wedges against to thereby lock said interacting portion and said receiving portion together.

3. The dental simulator of claim 2, wherein said locking mechanism further includes a biasing device, said protrusion being movable relative to said surface, said protrusion being biased by said biasing device against said surface.

4. The dental simulator of claim 3, wherein said locking mechanism further includes a release device that is movable to overcome said biasing device thereby moving said protrusion away from said surface to disengage said interacting portion from said receiving portion.

5. The dental simulator of claim 2, wherein said interacting portion and said receiving portion are inserted together along an insertion axis.

6. The dental simulator of claim 5, wherein both said interacting portion and said receiving portion have at least one double angle construct relative to said insertion axis, said double angle construct of said interacting portion being complimentary to said double angle construct of said receiving portion.

7. The dental simulator of claim 6, wherein said at least one double angle construct is two double angle constructs.

8. A locking mechanism for use with a dental simulator having a simulated teeth assembly and a manikin head, the locking mechanism comprising:
a receiving portion; and
an interacting portion slidingly engaged with said receiving portion to thereby secure the simulated teeth assembly to the manikin head, one of said receiving portion and said interacting portion being connectable to the simulated teeth assembly, the other of said receiving portion and said interacting portion being connectable to the manikin head.

9. The locking mechanism of claim 8, wherein said interacting portion has a protrusion and said receiving portion has a surface against which said protrusion wedges against to thereby lock said interacting portion and said receiving portion together.

10. The locking mechanism of claim 9, further comprising a biasing device, said protrusion being movable relative to said surface, said protrusion being biased by said biasing device against said surface.

11. The locking mechanism of claim 10, further comprising a release device that is movable to overcome said biasing device thereby moving said protrusion away from said surface to disengage said interacting portion from said receiving portion.

12. The locking mechanism of claim 9, wherein said interacting portion and said receiving portion are configured to be inserted together along an insertion axis.

13. The locking mechanism of claim 12, wherein both said interacting portion and said receiving portion have at least one double angle construct relative to said insertion axis, said double angle construct of said interacting portion being complimentary to said double angle construct of said receiving portion.

14. The locking mechanism of claim 13, wherein said at least one double angle construct is two double angle constructs.

15. A method of securing a simulated teeth assembly to a manikin head, the method comprising the steps of:
orienting a receiving portion of a locking mechanism with an interacting portion of said locking mechanism; and
sliding said receiving portion and said interacting portion together to thereby secure the simulated teeth assembly to the manikin head, one of said receiving portion and said interacting portion being connected to the simulated teeth assembly, the other of said receiving portion and said interacting portion being connected to the manikin head.

16. The method of claim 15, further comprising the step of wedging a movable protrusion of said interacting portion against a surface of said receiving portion to thereby lock said interacting portion and said receiving portion together.

17. The method of claim 16, further comprising the step of biasing said movable protrusion against said surface by way of a biasing device.

18. The method of claim 17, further comprising the step of releasing said interacting portion from said receiving portion by moving a release device to overcome the bias of said biasing device thereby moving said protrusion away from said surface.

19. The method of claim 16, wherein said interacting portion and said receiving portion are configured to be inserted together along an insertion axis.

20. The method of claim 19, wherein both said interacting portion and said receiving portion have at least one double angle construct relative to said insertion axis, said double angle construct of said interacting portion being complimentary to said double angle construct of said receiving portion.
